(19) United States
(12) Patent Application Publication
(10) Pub. No.: US 2026/0271173 A1
(43) Pub. Date: Sep. 10, 2026

(54) RESONATOR COIL PITCH ADJUSTMENT SYSTEMS AND METHODS

(71) Applicant: Applied Materials, Inc., Santa Clara, CA (US)

(72) Inventors: Jason M. Schaller, Austin, TX (US); Wai Ming Tam, Georgetown, MA (US); William Herron Park, JR., Marblehead, MA (US); David T. Blahnik, Round Rock, TX (US); Michael C. Simmons, Austin, TX (US)

(73) Assignee: Applied Materials, Inc., Santa Clara, CA (US)

(21) Appl. No.: 19/069,634

(22) Filed: Mar. 4, 2025

(51) Int. Cl. H05H 7/18; H05H 7/02

(52) U.S. Cl. CPC H05H 7/18; H05H 2007/025; H05H 2277/12

(57) ABSTRACT

The present subject matter relates to systems and methods for adjusting the resonant frequency of a resonator coil that is disposed within an enclosure. An adjustable coupling arrangement couples a first end of the resonator coil to the enclosure. The adjustable coupling arrangement is movable to adjust a position of the first end of the resonator coil with respect to the enclosure such that a pitch of the resonator coil is modified.

### TECHNICAL FIELD

The subject matter disclosed herein relates generally to resonator coils used in an ion implantation apparatus. In particular, the subject matter relates to systems and devices for adjusting the frequency of a resonating coil.

### BACKGROUND

In systems requiring a high amplitude RF voltage, resonator assemblies can be used to generate such voltages, effectively amplifying a given RF input. For example, such resonator assemblies can be used in ion implantation systems that introduce dopants or impurities into a substrate via bombardment using ion energies of approximately 1 MeV or greater. In particular, a linear accelerator (LINAC) can be used as a high-energy ion implanter in which a series of electrodes arranged as tubes conduct and accelerate an ion beam to increasingly higher energy along the succession of tubes, where the electrodes receive an AC voltage signal. Acceleration of ions in an RF-LINAC takes place by conducting packetized “bunches” of ions through a series of powered hollow electrodes, which electrodes may be referred to as “drift tubes.”

Resonator assemblies for use in this context can include a resonator coil as part of a resonance circuit to deliver a peak RF voltage at the end of the resonator coil that is connected to one of the powered drift tubes. The resonator may be described as having a resonator coil that acts as an inductor, which can be disposed within a grounded conductive enclosure (i.e., “a resonator can”). The proximity of the resonator can to the resonator coil results in an overall capacitance. The resonator coil (inductor), together with the capacitance of the resonator can, forms a parallel LC circuit having a resonant frequency of 1/(2π√LC).

In known systems, the resonance circuit is tuned so that the system maintains resonance at a resonant frequency that lies at or near the frequency of the incoming RF signal from an RF source. Standard LINACs are driven by a 13.56 MHz signal using many accelerator stages that each include a resonator circuit having a coil and capacitor. Moreover, the resonant frequency of each resonator corresponding to the different acceleration stages of a linear accelerator is to be maintained at the same frequency so that relative phase of RF voltage signals delivered at different resonators can be properly set and maintained. In some situations, however, the actual operating frequency of a resonator may not match the design specifications for any of a variety of reasons, including but not limited to manufacturing variation. In addition, the inductance of a resonator coil or capacitance of the resonator may change in operation due to mechanical, thermal, or other changes within the resonator.

To maintain proper resonance, in known systems, movable parts have been provided within the resonator enclosure, so as to slightly adjust the inductance or capacitance in the resonator and adjust the resonant frequency accordingly. In current systems, however, it can be difficult to access the components required for calibration, which increases tool downtime. In some known systems, movable parts have been provided within the resonator enclosure to slightly adjust the inductance or capacitance in the resonator and to adjust the resonant frequency accordingly. For example, present methods for adjusting the frequency of a resonator involve the use of a padding cap located on a high-voltage end of the resonator (e.g., in the resonator can). The padding cap position and size must change to account for changes in coil shape and other capacitance loads. In addition, having movable parts within a resonator enclosure may engender certain problems, such as wear and tear of movable parts and susceptibility to mechanical vibration. In addition, in some configurations, the tuning components also act as particle deposition shields. As a result, tuning the coil through this approach prevents optimizing the shielding characteristics.

With respect to these and other considerations, the present disclosure is provided.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In one aspect, a resonator may include an enclosure, a resonator coil disposed within the enclosure and configured to deliver a high voltage RF signal from a power input to a power output, and an adjustable coupling arrangement coupling a first end of the resonator coil to the enclosure. The adjustable coupling arrangement is movable to adjust a position of the first end of the resonator coil with respect to the enclosure such that a pitch of the resonator coil is modified.

In another aspect, an adjustable coupling device for coupling an end of a resonator coil to an enclosure may include a coupling housing comprising a channel that extends therethrough and an adjustment actuator configured to engage the end of the resonator coil, where the end of the resonator coil is configured to extend through the channel. In this configuration, the adjustment actuator is selectively movable to cause the end of the resonator coil to translate along the channel.

In another aspect, a method for adjusting the resonant frequency of a resonator coil can include positioning a resonator coil within an enclosure, coupling a first end of the resonator coil to the enclosure using an adjustable coupling arrangement, and selectively moving the adjustable coupling arrangement to adjust a position of the first end of the resonator coil with respect to the enclosure such that a pitch of the resonator coil is modified.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a perspective side view of a resonator assembly according to an embodiment of the presently disclosed subject matter.

FIG. 2 is a side cutaway view of an adjustable coupling arrangement for use with a resonator coil according to an embodiment of the presently disclosed subject matter.

FIG. 3 is a side cutaway view of an adjustable coupling arrangement for use with a resonator coil according to another embodiment of the presently disclosed subject matter.

FIG. 4 is a top perspective view of an adjustable coupling arrangement for use with a resonator coil according to an embodiment of the presently disclosed subject matter.

FIG. 5 is a flow chart illustrating a method for adjusting the resonant frequency of a resonator coil according to an embodiment of the presently disclosed subject matter.

The drawings are not necessarily to scale. The drawings are merely representations, not intended to portray specific parameters of the disclosure. The drawings are intended to depict exemplary embodiments of the disclosure, and therefore are not to be considered as limiting in scope. In the drawings, like numbering represents like elements.

### DETAILED DESCRIPTION

Methods and devices in accordance with the present disclosure will now be described more fully hereinafter with reference to the accompanying drawings, where various embodiments are shown. The methods and devices may be embodied in many different forms and are not to be construed as being limited to the embodiments set forth herein. Instead, these embodiments are provided so the disclosure will be thorough and complete, and will fully convey the scope of the methods to those skilled in the art.

Provided herein are approaches for improved linear accelerator control, and improved high energy ion implantation systems, based upon a beamline architecture using a linear accelerator. For brevity, an ion implantation system may also be referred to herein as an “ion implanter.” Various embodiments provide novel configurations for providing the capability of generating high energy ions, where the final ion energy delivered to a substrate may be 300 keV, 500 keV, 1 MeV or greater. In exemplary embodiments, a novel resonance circuit arrangement and techniques are provided for adjusting resonance in acceleration stages of RF LINACs.

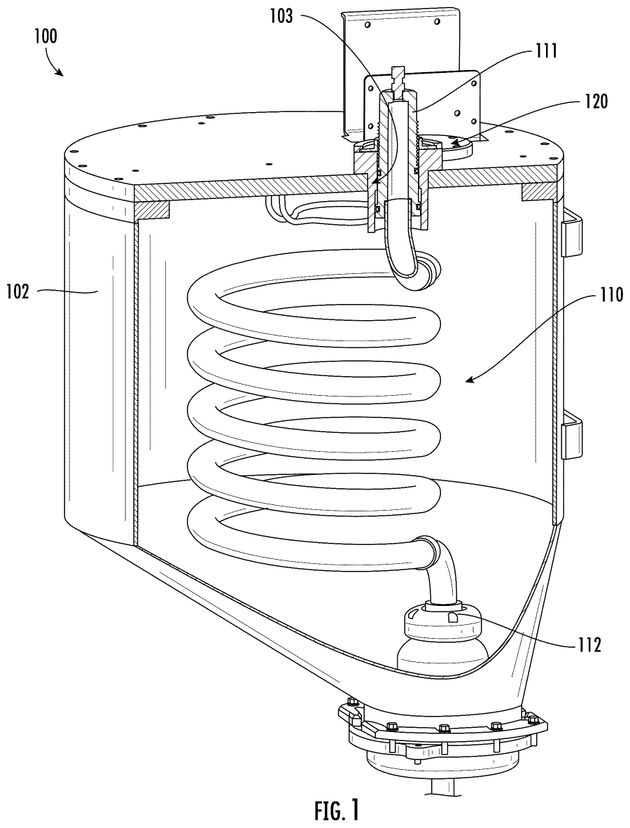

FIG. 1 illustrates one exemplary architecture for resonance control. In the illustrated embodiment, a resonator, generally designated 100, includes an enclosure 102 in which a resonator coil 110 is disposed. In some embodiments, the interior of the enclosure 102 can be pressurized to help establish desired operating conditions for the resonator coil 110. In this configuration, a resonant network is created by the distributed inductance of the resonator coil 110 and a distributed capacitance of the resonator coil 110 to the resonator enclosure 102. This inductance together with the capacitance creates an LC tank circuit with the resonant frequency f₀, where f₀=1/(2π√LC). As discussed previously, the resonator coil 110 is configured to deliver a high voltage RF signal from a power input to a power output, which in some examples can be connected to a powered electrode of a drift tube assembly as discussed above.

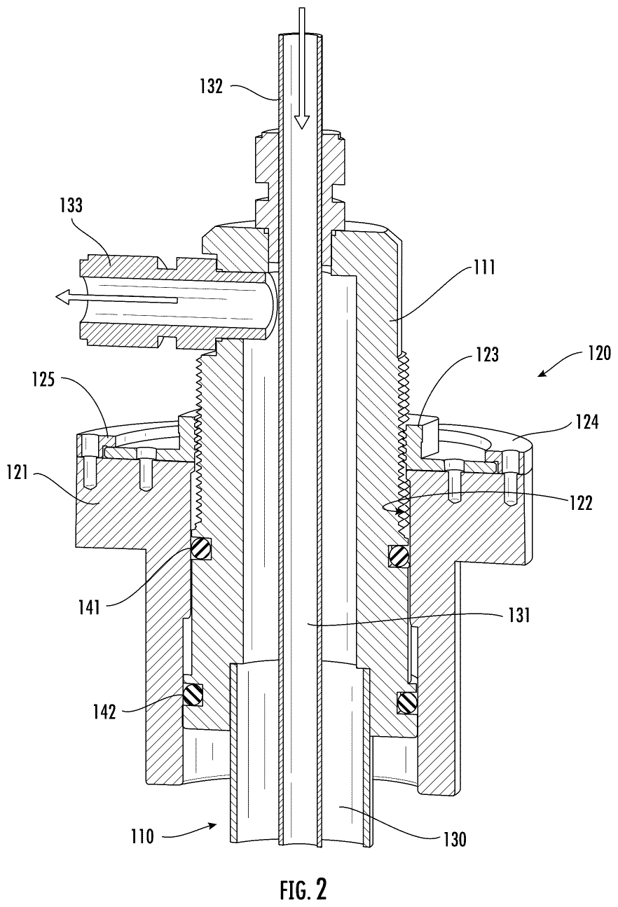

In addition, the resonator coil 110 can further be integrated with a cooling circuit that is configured to regulate a temperature of the resonator coil 110. Referring to FIG. 2, in some examples, the resonator coil 110 can include an outer tube 130 that defines the structure and shape of the resonator coil 110. In some embodiments, the outer tube 130 further serves as a return line for coolant that is flowed through the cooling circuit. An inner tube 131 can further be arranged within the outer tube 130 along substantially an entire length of the outer tube 130. In the illustrated embodiment, the inner tube 131 is coupled to a coolant inlet 132 at or near a first end 111 of the resonator coil 110, and the inner tube 131 can include one or more opening at or near a second end 112 of the resonator coil 110 that is substantially opposite the first end 111. The outer tube 130 is coupled to a coolant outlet 133 at or near the first end 111 of the resonator coil 110 and sealed at the second end 112 of the resonator coil 110. Appropriate fittings can connect to the coolant inlet 132 and the coolant outlet 133 to provide connections to flexible tubing of the cooling circuit. In this arrangement, a flow of coolant can be supplied through the inner tube 131 from the first end 111 toward the second end 112 and returned through the outer tube 130 from the second end 112 to the first end 111. This counter-flow configuration can thereby provide effective cooling of the resonator coil 110.

The initial geometry of the resonator enclosure 102 and the inductor (resonator coil 110) are modeled and chosen so that the resonant frequency is ideally the same as the operating frequency of the linear accelerator, which frequency may be set at the nominal frequency of an associated RF power source, such as 13.56 MHz. The power loss of a resonator is thus minimized when the resonant frequency matches the operating frequency of the linear accelerator. In some implementations of RF LINACs, however, the resonant frequency is not always the same as the desired operating frequency. For example, deviation of the resonant frequency may occur due to manufacturing tolerances affecting the pitch of the resonator coil 110 and the exact shaping of the different windings of the resonator coil 110. Also, during operation under high power RF, the temperature of the resonator coil 110 and resonator enclosure 102 can increase, resulting in thermal expansion of the resonator coil and resonator enclosure 102. This expansion changes the overall inductance and capacitance of the system and accordingly changes the resonant frequency.

The present embodiments address the above issue using an adjustable coupling arrangement to secure the resonator coil 110 within the enclosure 102. Referring to FIG. 2, an adjustable coupling arrangement, generally designated 120, couples the first end 111 of the resonator coil 110 to the enclosure 102. In the illustrated embodiment, the coupling arrangement 120 includes a coupling housing 121 that is positioned within a port/opening 103 in the enclosure 102 and defines a channel 122 through which the first end 111 of the resonator coil 110 extends. In some embodiments, such as in the configuration shown in FIGS. 1 and 2, the coupling housing 121 can be a unitary body that is positioned within the opening 103 in the enclosure. Such a coupling housing 121 can be secured within the opening 103 by any known means, including but not limited to welding, adhesives, or one or more fasteners.

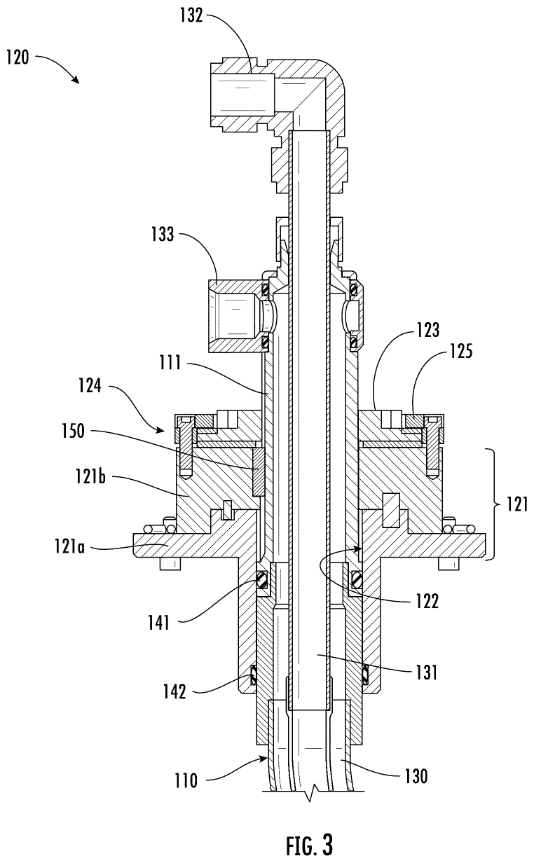

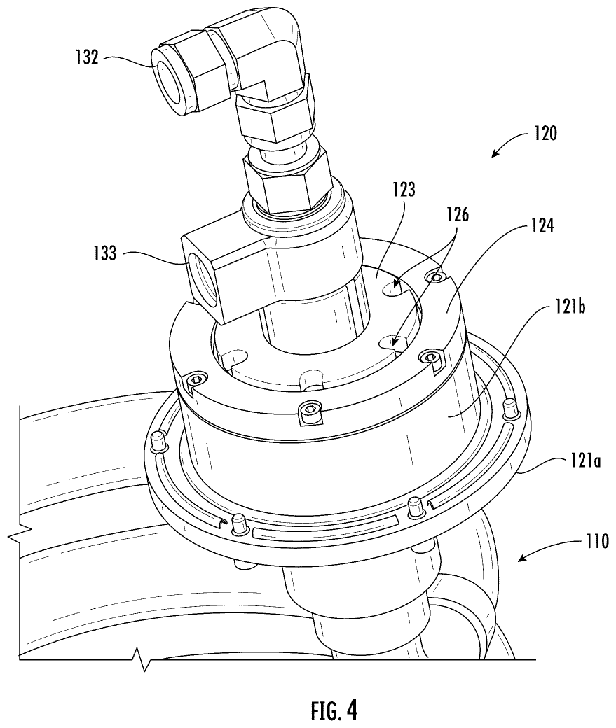

Alternatively, in some embodiments, the coupling housing 121 can include a multi-part housing assembly, such as is shown in FIGS. 3 and 4. In the illustrated configuration, the multi-part housing assembly has a coupling base 121a that is configured to be secured to an interior of the enclosure 102 and a coupling block 121b that is secured to the coupling base 121a and that is configured to extend out of the opening 103. In such a configuration, the pressurized environment established inside the enclosure 102 can help to secure the coupling arrangement 120 in place.

Regardless of the particular configuration, the adjustable coupling arrangement 120 includes an adjustment actuator 123 that is positioned against the coupling housing 121 and is configured to engage the first end 111 of the resonator coil 110. In some embodiments, for example, the adjustment actuator 123 is provided in the form of a nut that is threadedly coupled to the first end 111 of the resonator coil 110.

In some embodiments, the adjustment actuator 123 is secured against the coupling housing 121 by a clamping element 124 that is attached to the coupling housing 121 and arranged to cover at least a portion of the adjustment actuator 123 to thereby prevent the adjustment actuator 123 from being moved away from the coupling housing 121. In the illustrated example, the clamping element 124 defines a substantially circular cavity in which the adjustment actuator 123 is arranged, the clamping element 124 having an inner diameter that is larger than an outer diameter of the adjustment actuator 123. A flange 125 extends inwardly over an outer peripheral edge of the adjustment actuator 123. In this arrangement, the clamping element 124 and the coupling housing 121 effectively encapsulate at least a portion of the adjustment actuator 123.

The adjustment actuator 123 can remain free to rotate in place, however, with such rotation being translated into a linear translation of the first end 111 of the resonator coil 110 due to the threaded connection of the adjustment actuator 123 to the first end 111. In some embodiments, the linear adjustment of the first end 111 can correspond to the rotation of the adjustment actuator 123 based on a known measure of the thread-per-inch (TPI) of the adjustment actuator 123. The resonant frequency of the resonator coil 110 can thus be adjusted to a desired value by controlling the rotation of the adjustment actuator 123 to correspond to an appropriate translation of the first end 111 that effectively adjusts the configuration of the resonator coil 110 to exhibit the desired resonance.

In some embodiments, the adjustment actuator 123 can include an arrangement of surface features 126 that are configured to be engaged by corresponding features of an adjustment tool to rotate the adjustment actuator 123. In the configuration shown in FIG. 3, for example, the surface features 126 are a plurality of indentations that are configured to be engaged by corresponding protrusions of a pin spanner wrench.

Regardless of the particular configuration of the adjustable coupling arrangement 120 the position of the first end 111 of the resonator coil 110 can be adjusted by correspondingly adjusting the position of the adjustment actuator 123. In contrast, an opposing second end 112 of the resonator coil 110 is securely attached to the enclosure 102. In this arrangement, manipulation of the adjustment actuator 123 can cause the first end 111 to move toward or away from the second end 112, effectively stretching or compressing the coil. In some examples, the translation of the first end 111 can be configured to cause the spacing between the windings of the resonator coil 110 to change substantially uniformly (i.e., to stretch the coil evenly). Such changes in shape change the pitch of the resonator coil 110 and correspondingly change the frequency of the resonator coil 110. In some embodiments, the change in the resonant frequency can be measured in real time during adjustment of the adjustable coupling arrangement 120.

In some embodiments, the first end 111 of the resonator coil 110 can be rotationally coupled to the coupling housing 121 (or to the coupling base 121a and/or coupling block 121b) while remaining free to translate relative to the coupling housing 121 along the channel 122. Such rotational restriction can be achieved by configuring the first end 111 and/or the coupling housing 121 to include a surface feature or geometry that is rotationally locked with respect to the corresponding structure. Alternatively, as shown in FIG. 3, one or more alignment/guide pins 150 can be inserted between the first end 111 and the coupling housing 121 (e.g., between the first end 111 and the coupling block 121b) to prevent relative rotation of the components while allowing translation of the first end 111 into or out of the enclosure 102 relative to the coupling housing 121.

In some embodiments, the interface between the first end 111 and the coupling housing 121 can include one or more O-rings 141 configured to continuously seal the enclosure 102, even with adjustments to the position of the first end 111. Any adjustment to the pitch of the resonator coil 110 can thus be performed while the resonator coil 110 is enclosed in the pressurized enclosure 102. In this way, the system allows frequency tuning without venting the pressure chamber or venting the resonator assembly. Such a configuration can thereby reduce calibration time and tool downtime.

In some embodiments, the interface between the first end 111 and the coupling housing 121 can further include one or more electromagnetic interference (EMI)/radio frequency (RF) gaskets 142 configured to manage an RF ground path to the walls of the enclosure 102 and to prevent unwanted signal leaks to protect against electromagnetic interference and radio frequency interference.

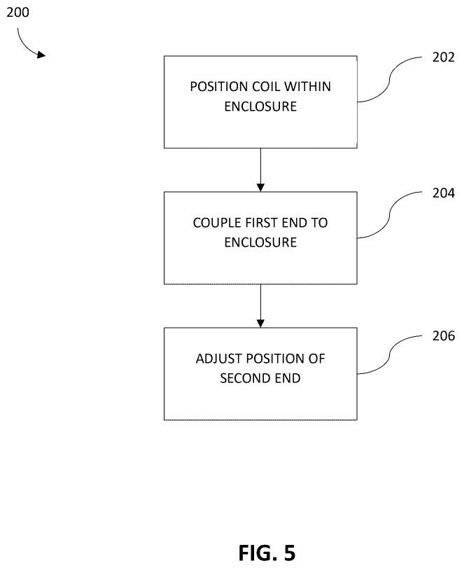

In another aspect, methods for adjusting the resonant frequency of a resonator coil are illustrated in FIG. 5. The method for adjusting the resonant frequency, generally designated 200, can include an assembly process 202 in which a resonator coil 110 is positioned within an enclosure 102, wherein the resonator coil 110 is configured to deliver a high voltage RF signal from a power input to a power output. The method 200 can further include a coupling process 204 in which a first end 111 of the resonator coil 110 is coupled to the enclosure 102 using an adjustable coupling arrangement 120. As discussed above, in some examples, the coupling process 204 can include positioning a coupling housing 121 within an opening of the enclosure 102, extending the first end 111 of the resonator coil 110 through a channel 122 that extends through the coupling housing 121, positioning an adjustment actuator 123 against the coupling housing 121, and engaging the first end 111 of the resonator coil 110 with the adjustment actuator 123. In this way, selectively moving the adjustable coupling arrangement 120 can involve moving the adjustment actuator 123 to cause the first end 111 of the resonator coil 110 to translate along the channel 122.

Finally, an adjustment process 206 can include selectively moving the adjustable coupling arrangement 120 to adjust a position of the first end 111 of the resonator coil 110 with respect to the enclosure 102 such that a pitch of the resonator coil 110 is modified. In the examples discussed above in which the adjustment actuator 123 is threadedly coupled to the first end 111 of the resonator coil 110, the adjustment process 206 can involve rotating the adjustment actuator 123 relative to the coupling housing 121 to cause the first end 111 of the resonator coil 110 to translate along the channel 122.

As used herein, an element or operation recited in the singular and proceeded with the word “a” or “an” is to be understood as including plural elements or operations, until such exclusion is explicitly recited. Furthermore, references to “one embodiment” of the present disclosure are not intended as limiting. Additional embodiments may also incorporate the recited features.

Furthermore, the terms “substantial” or “substantially,” as well as the terms “approximate” or “approximately,” can be used interchangeably in some embodiments, and can be described using any relative measures acceptable by one of ordinary skill in the art. For example, these terms can serve as a comparison to a reference parameter, to indicate a deviation capable of providing the intended function. Although non-limiting, the deviation from the reference parameter can be, for example, in an amount of less than 1%, less than 3%, less than 5%, less than 10%, less than 15%, less than 20%, and so on.

Still furthermore, one of ordinary skill will understand when an element such as a layer, region, or substrate is referred to as being formed on, deposited on, or disposed “on,” “over” or “atop” another element, the element can be directly on the other element or intervening elements may also be present. In contrast, when an element is referred to as being “directly on,” “directly over” or “directly atop” another element, no intervening elements are present.

While certain embodiments of the disclosure have been described herein, the disclosure is not limited thereto, as the disclosure is as broad in scope as the art will allow and the specification may be read likewise. Therefore, the above description is not to be construed as limiting. Instead, the above description is merely as exemplifications of particular embodiments. Those skilled in the art will envision other modifications within the scope and spirit of the claims appended hereto.

What is claimed is:

1. A resonator comprising:
an enclosure;
a resonator coil disposed within the enclosure and configured to deliver a high voltage RF signal from a power input to a power output; and
an adjustable coupling arrangement coupling a first end of the resonator coil to the enclosure;
wherein the adjustable coupling arrangement is movable to adjust a position of the first end of the resonator coil with respect to the enclosure such that a pitch of the resonator coil is modified.

2. The resonator of claim 1, wherein the adjustable coupling arrangement comprises:
a coupling housing positioned within an opening of the enclosure and comprising a channel that extends through the coupling housing;
an adjustment actuator positioned against the coupling housing and configured to engage the first end of the resonator coil;
wherein the first end of the resonator coil extends through the channel; and
wherein the adjustment actuator is selectively movable to cause the first end of the resonator coil to translate along the channel.

3. The resonator of claim 2, wherein the coupling housing comprises:
a coupling base secured to an interior of the enclosure; and
a coupling block secured to the coupling base and configured to extend out of the opening.

4. The resonator of claim 2, wherein the adjustment actuator is threadedly coupled to the first end of the resonator coil, wherein rotation of the adjustment actuator relative to the coupling housing causes the first end of the resonator coil to translate along the channel.

5. The resonator of claim 2, wherein the adjustment actuator is secured against the coupling housing by a clamping element that is attached to the coupling housing.

6. The resonator of claim 1, wherein the resonator coil comprises:
an outer tube; and
an inner tube arranged within the outer tube along substantially an entire length of the outer tube;
wherein the inner tube is coupled to a coolant inlet at or near the first end of the resonator coil and includes one or more opening at or near a second end of the resonator coil substantially opposite the first end; and
wherein the outer tube is coupled to a coolant outlet at or near the first end of the resonator coil and is sealed at or near the second end of the resonator coil.

7. An adjustable coupling device for coupling an end of a resonator coil to an enclosure, the device comprising:
a coupling housing comprising a channel that extends therethrough;
an adjustment actuator configured to engage the end of the resonator coil;
wherein the end of the resonator coil is configured to extend through the channel;
wherein the adjustment actuator is selectively movable to cause the end of the resonator coil to translate along the channel.

8. The device of claim 7, wherein the adjustment actuator is configured to be threadedly coupled to the end of the resonator coil, wherein rotation of the adjustment actuator relative to the coupling housing causes the end of the resonator coil to translate along the channel.

9. The device of claim 8, wherein the adjustment actuator comprises an arrangement of surface features that are configured to be engaged by corresponding features of an adjustment tool to rotate the adjustment actuator.

10. The device of claim 9, wherein the surface features comprise a plurality of indentations that are configured to be engaged by corresponding protrusions of a pin spanner wrench.

11. The device of claim 7, wherein the adjustment actuator is secured against the coupling housing by a clamping element that is attached to the coupling housing.

12. A method for adjusting the resonant frequency of a resonator coil, the method comprising:
positioning a resonator coil within an enclosure, wherein the resonator coil is configured to deliver a high voltage RF signal from a power input to a power output;
coupling a first end of the resonator coil to the enclosure using an adjustable coupling arrangement;
selectively moving the adjustable coupling arrangement to adjust a position of the first end of the resonator coil with respect to the enclosure such that a pitch of the resonator coil is modified.

13. The method of claim 12, wherein coupling a first end of the resonator coil comprises:
positioning a coupling housing within an opening of the enclosure;
extending the first end of the resonator coil through a channel that extends through the coupling housing;
positioning an adjustment actuator against the coupling housing; and
engaging the first end of the resonator coil with the adjustment actuator;
wherein selectively moving the adjustable coupling arrangement comprises moving the adjustment actuator to cause the first end of the resonator coil to translate along the channel.

14. The method of claim 13, wherein engaging the first end of the resonator coil with the adjustment actuator comprises threadedly coupling the adjustment actuator to the first end of the resonator coil; and
wherein moving the adjustment actuator comprises rotating the adjustment actuator relative to the coupling housing to cause the first end of the resonator coil to translate along the channel.

15. The method of claim 14, wherein rotating the adjustment actuator relative to the coupling housing comprises:
engaging an arrangement of surface features provided on the adjustment actuator with an adjustment tool; and
rotating the adjustment tool to correspondingly rotate the adjustment actuator.

16. The method of claim 15, wherein the surface features comprise a plurality of indentations; and
wherein engaging an arrangement of surface features comprises engaging the indentations with corresponding protrusions of a pin spanner wrench.

17. The method of claim 13, wherein the adjustment actuator is secured against the coupling housing by a clamping element that is attached to the coupling housing.

18. The method of claim 12, wherein the resonator coil comprises:
an outer tube comprising a coolant outlet at or near the first end of the resonator coil; and
an inner tube arranged within the outer tube along substantially an entire length of the outer tube, the inner tube being coupled to a coolant inlet at or near the first end of the resonator coil, and the inner tube comprising one or more opening at or near a second end of the resonator coil substantially opposite the first end; and
wherein the method comprises:
supplying a flow of coolant through the inner tube from the first end toward the second end; and
returning the flow of coolant through the outer tube from the second end to the first end.
